(19) United States
(12) Patent Application Publication
(10) Pub. No.: US 2015/0228223 A1
(43) Pub. Date: Aug. 13, 2015

(54) ORGANIC LIGHT-EMITTING DISPLAY DEVICE

(71) Applicant: Samsung Display Co., Ltd., Yongin-City (KR)

(72) Inventor: Jin-Woo Park, Yongin-City (KR)

(21) Appl. No.: 14/297,514

(22) Filed: Jun. 5, 2014

(30) Foreign Application Priority Data
Feb. 13, 2014 (KR) 10-2014-0016799

(51) Int. Cl. G09G 3/32; G09G 3/20

(52) U.S. Cl. CPC G09G 3/3233; G09G 3/2003

(57) ABSTRACT

An organic light-emitting display device includes two unit pixels immediately neighboring each other, and each comprising a plurality of subpixels, each of which is configured to emit light having one of red, blue, and green colors; and a power line extending in a direction to apply a voltage to each of the plurality of subpixels in order for the plurality of subpixels to emit light. The subpixels included in the two unit pixels are arranged such that the number of the subpixels that are configured to emit light having a first color or a second color among the red, blue, and green colors and are disposed on one side of the power line is the same as that of the subpixels that are configured to emit light having the first color or the second color and are disposed on the other side of the power line.

### RELATED APPLICATIONS

This application claims the benefit of Korean Patent Application No. 10-2014-0016799, filed on Feb. 13, 2014, in the Korean Intellectual Property Office, the disclosure of which is incorporated herein in its entirety by reference.

### BACKGROUND

1. Field

One or more embodiments of the present invention relate to an organic light-emitting display device.

2. Description of the Related Art

From among the many types of display devices, organic light-emitting display devices have been spotlighted as the next-generation display devices because of their wide viewing angle, high contrast ratio, and fast response time.

An organic light-emitting display device includes a substrate, a thin-film transistor (TFT) array that includes a plurality of TFTs and at least one capacitor and is disposed on the substrate, and an organic light-emitting device (OLED) that is connected to the TFT array. The TFT array is formed by stacking a layer formed of a semiconductor material, a layer formed of a conductive material, and a layer formed of an insulating material for insulating the layers. Each layer is patterned into a predetermined shape to overlap or not to overlap at a predetermined position.

However, in a process of patterning the layers, a patterning mask may be misaligned and thus layers that need to overlap with each other may not overlap or may partially overlap. In this case, an undesired coupling capacitance may be formed, a plurality of light-emitting devices may suffer from luminance non-uniformity, and thus, a color shift may occur.

### SUMMARY

One or more embodiments of the present invention provide an organic light-emitting display device including subpixels that are arranged to prevent color shift.

One aspect of the invention provides an organic light-emitting display device, which comprises: a substrate; two unit pixels disposed over the substrate, immediately neighboring each other, and each comprising a plurality of subpixels, each of which is configured to emit light having one of red, blue, and green colors; and a power line formed over the substrate, extending in a direction to apply a voltage to each of the plurality of subpixels in order for the plurality of subpixels to emit light, wherein the subpixels included in the two unit pixels are arranged such that the number of the subpixels that are configured to emit light having a first color or a second color among the red, blue, and green colors and are disposed on one side of the power line may be the same as that of the subpixels that are configured to emit light having the first color or the second color and are disposed on the other side of the power line.

In the foregoing device, each unit pixel may comprise one red subpixel configured to emit light having the red color, one blue subpixel configured to emit light having the blue color, and two green subpixels configured to emit light having the green color. The red subpixel and one of the green subpixels may immediately neighbor each other and be disposed on one side and the other side of the power line, respectively, and wherein the blue subpixel and the remaining green subpixel immediately neighbor each other and are disposed on one side and the other side of the power line, respectively.

Still in the foregoing device, each of the plurality of subpixels may comprise an organic light-emitting device (OLED), a driving thin-film transistor (TFT) connected to the OLED to supply driving current to the OLED and comprising a semiconductor and a gate electrode, and a capacitor connected to the driving TFT and comprising a lower electrode and an upper electrode, wherein the driving TFT and the capacitor overlap each other when viewed in a viewing direction perpendicular to a major surface of the substrate, wherein the gate electrode of the driving TFT and the lower electrode of the capacitor are integrated as a single piece. The plurality of subpixels may comprise two subpixels that immediately neighbor each other and are disposed on one side and the other side of the power line, respectively, wherein the upper electrodes of the capacitors of the two subpixels are integrated as a single piece. The power line may contact a central portion of the single piece of the upper electrodes to apply the voltage to the two subpixels. The driving TFTs included in the two subpixels are symmetric with respect to the power line. The semiconductor in the driving TFT may have a curved shape with multiple turns. The OLED may comprise a pixel electrode, a counter electrode opposing the pixel electrode, and an organic light-emitting layer that is disposed between the pixel electrode and the counter electrode and configured to emit light, wherein the pixel electrode configured to reflect the light to the counter electrode. The OLED may overlap and cover the driving TFT and the capacitor when viewed in the viewing direction.

Another aspect of the invention provides an organic light-emitting display device, which comprises: a substrate; a plurality of color pixels formed over the substrate, and comprising first color pixels each configured to emit light having a first color, second color pixels each configured to emit light having a second color, and third color pixels each configured to emit light having a third color; and a power line formed over the substrate and extending in an extending direction to apply a voltage to each of the plurality of color pixels in order for the plurality of color pixels to emit light, wherein each of the plurality of color pixels is disposed on a first side of the power line or a second side of the power line opposite the first side, wherein the number of the first color pixels disposed on the first side is substantially the same as that of the first color pixels disposed on the second side.

In the foregoing device, the number of the second color pixels disposed on the first side may be substantially the same as that of the second color pixels disposed on the second side. The first color pixels may be arranged such that each of the first color pixels disposed on the first side is disposed side by side with one of the third color pixels disposed on the second side. Each of the first color pixels disposed on the first side may be paired with one of the third color pixels disposed on the second side such that the paired first and third color pixels are disposed side by side with each other, wherein each of the paired first and third color pixels comprises a capacitor, wherein the capacitors of the paired first and third color pixels comprise a single common electrode. The first color pixels may be arranged such that each of the first color pixels disposed on the first side is disposed side by side with one of the third color pixels disposed on the second side, wherein the second color pixels are arranged such that each of the second color pixels disposed on the first side is disposed side by side with one of the third color pixels disposed on the second side.

Still in the foregoing device, the plurality of color pixels may be arranged on the first side or the second side such that each of the first color pixels disposed on the first side is not disposed side by side with one of the first color pixels disposed on the second side. The plurality of color pixels may be arranged on the first side or the second side such that each of the first color pixels disposed is not disposed side by side with another first color pixel. The first color is red, the second color is blue and the third color is green. The plurality of color pixels may have substantially the same size when viewed in a viewing direction perpendicular to a major surface of the substrate.

According to one or more embodiments of the present invention, an organic light-emitting display device includes: a unit pixel that is disposed on a substrate and includes a plurality of subpixels that each emit red, blue, or green light; and a power line that extends in a direction and transmits a voltage to each of the plurality of subpixels in order for the plurality of subpixels to emit light, wherein the plurality of subpixels included in at least two unit pixels that are adjacent to each other in the direction in which the power line extends are arranged such that the numbers of subpixels that emit light of at least two colors from among the red, blue, and green light and are separately disposed on one side and on other side of the power line are the same.

The unit pixel may include one red subpixel, one blue subpixel, and two green subpixels.

The plurality of subpixels may be arranged such that the red subpixel and one green subpixel face each other with respect to the power line, and the blue subpixel and the remaining green subpixel face each other with respect to the power line.

Each of the plurality of subpixels may include an organic light-emitting device (OLED) that emits the red, blue, or green light, a driving thin-film transistor (TFT) that is connected to the OLED, determines a driving current, supplies the driving current to the OLED, and includes a semiconductor portion and a gate electrode, and a capacitor that is connected to the driving TFT and includes a lower electrode and an upper electrode, wherein the driving TFT and the capacitor overlap each other so that the gate electrode that is included in the driving TFT and the lower electrode that is included in the capacitor are commonly formed.

Two subpixels that face each other with respect to the power line may commonly use the upper electrode of the capacitor.

The power line may contact a central portion of the commonly used upper electrode, and transmit the voltage to the two subpixels that face each other with respect to the power line.

The driving TFTs included in the two subpixels that face each other may be symmetric with respect to the power line.

The semiconductor portion in the driving TFT may have a curved shape with multiple turns.

The OLED may include a pixel electrode, a counter electrode that faces the pixel electrode, and an organic light-emitting layer that is disposed between the pixel electrode and the counter electrode and emits light, wherein the pixel electrode reflects the light to the counter electrode.

The OLED may overlap and cover the driving TFT and the capacitor.

Additional aspects are set forth in the detailed description, and will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a plan view illustrating an organic light-emitting display device according to an embodiment of the present invention;

FIG. 2 is a detailed plan view illustrating portion II of FIG. 1;

FIG. 3 is a cross-sectional view taken along line III-III of FIG. 2;

FIG. 4 is a plan view illustrating an organic light-emitting display device according to a comparative example; and

FIG. 5 is a detailed plan view illustrating portion V of FIG. 4.

### DETAILED DESCRIPTION

The present invention will now be described more fully with reference to the accompanying drawings, in which exemplary embodiments of the invention are shown. The advantages and features of the present invention and methods of achieving the advantages and features will be described more fully with reference to the accompanying drawings, in which exemplary embodiments of the invention are shown. In this regard, the present embodiments may have different forms and should not be construed as being limited to the descriptions set forth herein.

Reference will now be made in detail to embodiments, examples of which are illustrated n the accompanying drawings. In the drawings, the same elements are denoted by the same reference numerals.

As used herein, the term “and/or” includes any and all combinations of one or more of the associated listed items. Expressions such as “at least one of,” when preceding a list of elements, modify the entire list of elements and do not modify the individual elements of the list.

The term “unit pixel” used herein refers to a collection of subpixels that may emit white light. Accordingly, a unit pixel includes a plurality of subpixels. For example, a unit pixel may include a red subpixel, a blue subpixel, and a green subpixel. However, the present invention is not limited thereto, and a unit pixel may include four or more subpixels. According to an embodiment of the present invention, a unit pixel may include a red subpixel, a blue subpixel, a green subpixel and an additional green subpixel.

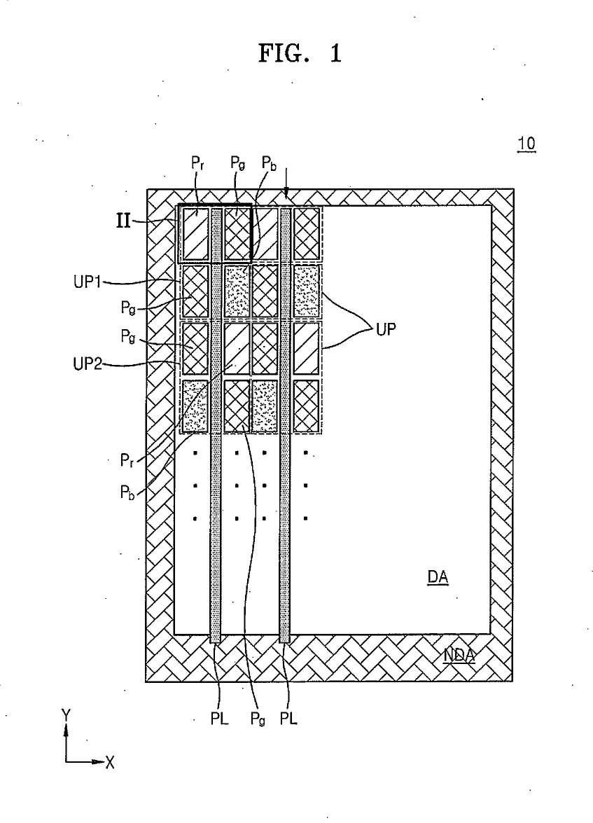

FIG. 1 is a plan view illustrating an organic light-emitting display device 10 according to an embodiment of the present invention.

Referring to FIG. 1, the organic light-emitting display device 10 is divided into a display area DA, in which an image is formed on a substrate, and a non-display area NDA that is formed around the display area DA. A plurality of unit pixels UP are provided in the display area DA. Each of the unit pixels UP may emit white light. To this end, each unit pixel UP includes a plurality of subpixels or color pixels. As described above, subpixels constituting each unit pixel UP may be one red subpixel or red color pixel Pᵣ, one blue subpixel or blue color pixel P_{b}, and two green subpixels or green color pixels P_{g}.

The organic light-emitting display device 10 of FIG. 1 has a high resolution. To this end, more unit pixels UP have to be provided in the display area DA. To this end, an attempt has been made to commonly use one line in a plurality of subpixels included in one unit pixel UP in order to reduce the number of lines that occupy a large space. In FIG. 1, a first power line or power wire PL that transmits a first power voltage to a subpixel may be commonly used in a plurality of subpixels included in one unit pixel UP. The first power voltage may be a high potential voltage that is used to determine a driving current of an organic light-emitting device (OLED). The first power line extends in a direction, for example, a Y direction, to cross the display area DA.

For convenience of explanation, from among the plurality of unit pixels UP that are provided in the display area DA, an arbitrary unit pixel UP is selected and is referred to as a first unit pixel UP1, and a unit pixel that is adjacent to the first unit pixel UP1 in an extension direction in which the first power line PL extends is referred to as a second unit pixel UP2. Each of the first unit pixel UP1 and the second unit pixel UP2 includes one red subpixel Pᵣ, one blue subpixel P_{b}, and two green subpixels P_{g}. Subpixels included in each of the first unit pixel UP1 and the second unit pixel UP2 are electrically connected to the first power line PL of a first column (hereinafter, referred to as a first power line PL1). The subpixels included in each of the first unit pixel UP1 and the second unit pixel UP2 are electrically connected to the first power line PL of the first column PL1. That is, the subpixels included in each of the first unit pixel UP1 and the second unit pixel UP2 commonly use the first power line PL of the first column PL1.

In FIG. 1, regarding a combination of the first unit pixel UP1 and the second unit pixel UP2, the number of the red subpixels Pᵣ, the blue subpixels P_{b}, or the green subpixels P_{g} on one side (for example, a left side) and the number of the red subpixels Pᵣ, the blue subpixels P_{b}, or the green subpixels P_{g} on the other side (for example, a right side) of the first power line PL are the same.

Referring to FIG. 1, regarding a combination of the first unit pixel UP1 and the second unit pixel UP2, the number of the red subpixels Pᵣ that are disposed on the left side of the first power line PL of the first column PL1 is 1, and the number of the red subpixels Pᵣ that are disposed on the right side of the first power line PL of the first column PL1 is also 1. The number of the blue subpixels P_{b} that are disposed on the left side of the first power line PL of the first column PL1 is 1, and the number of the blue subpixels that are disposed on the right side of the first powering line PL of the first column PL1 is also 1. Finally, the number of the green subpixels P_{g} that are disposed on the left side of the first power line PL of the first column PL1 is 2, and the number of the green subpixels P_{g} that are disposed on the right side of the first power line PL of the first column PL1 is also 2.

An arrangement of subpixels in FIG. 1 is exemplary, and the present embodiment of FIG. 1 is not limited thereto as long as subpixels that are included in at least two unit pixels UP that are disposed adjacent to each other in the extension direction of the first power line PL and are electrically connected to the first power line PL are arranged such that the number of subpixels of a specific color that are disposed on one side of the first power line PL and the number of subpixels of the specific color that are disposed on other side of the first power line PL are the same.

In FIG. 1, the green subpixel P_{g} and the red or blue subpixel Pᵣ or P_{b} face each other about the first power line PL. Alternatively, the red subpixel Pᵣ and the blue subpixel P_{b} may face each other and the green subpixels P_{g} may face each other. However, in this case, it is difficult to obtain uniform white light when compared to a case of FIG. 1. Accordingly, it is preferable that the green subpixel P_{g} and a subpixel of another color face each other with respect to the first power line PL as shown in FIG. 1.

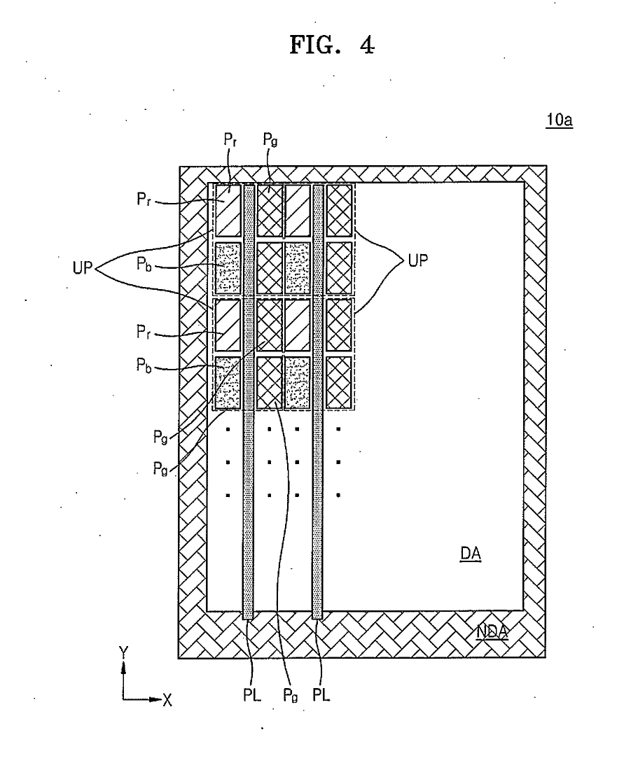

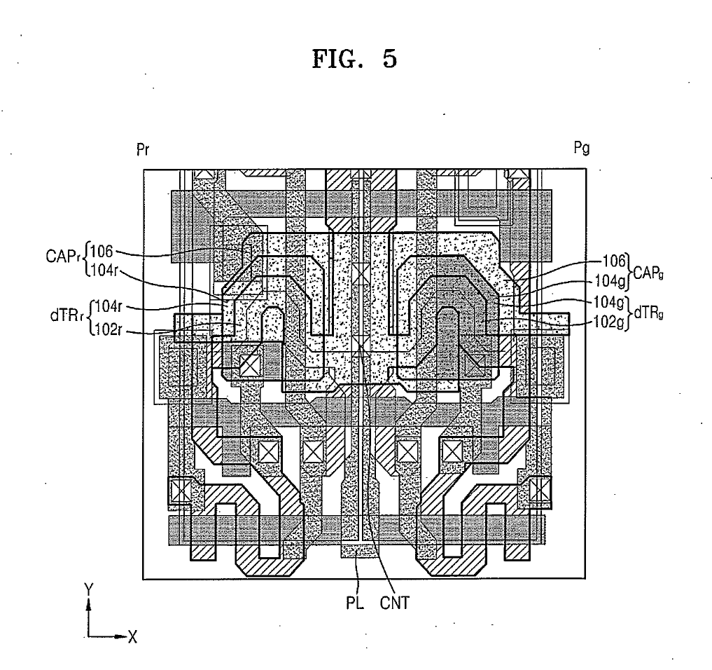

Accordingly, in FIG. 1, even when an undesired coupling capacitance is formed due to misalignment of a patterning mask during a process of manufacturing the organic light-emitting display device 10 or a luminance of a subpixel that emits light of a predetermined color is increased or reduced due to an insufficient capacitance, luminance non-uniformity over the entire display area DA may be offset and a uniform color image may be displayed without color shift, which will be explained in more detail below with reference to FIGS. 4 and 5.

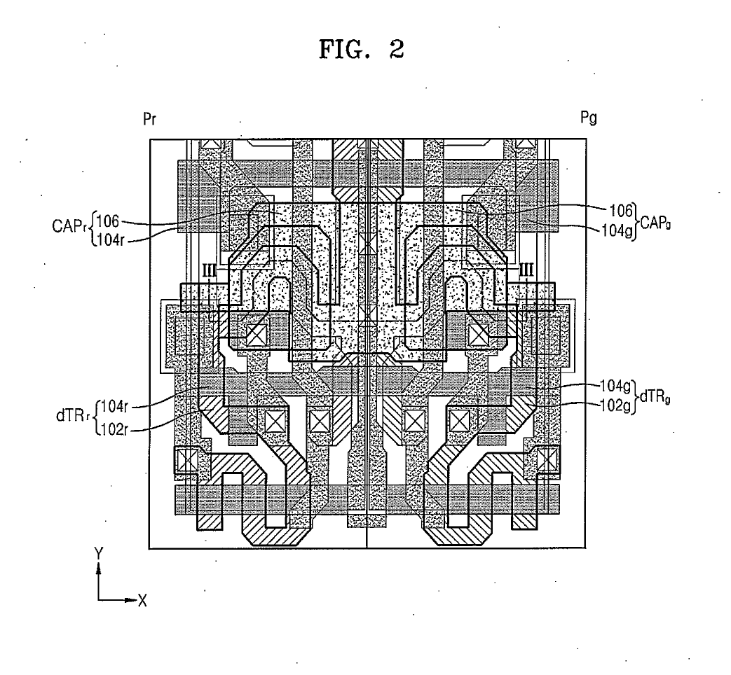

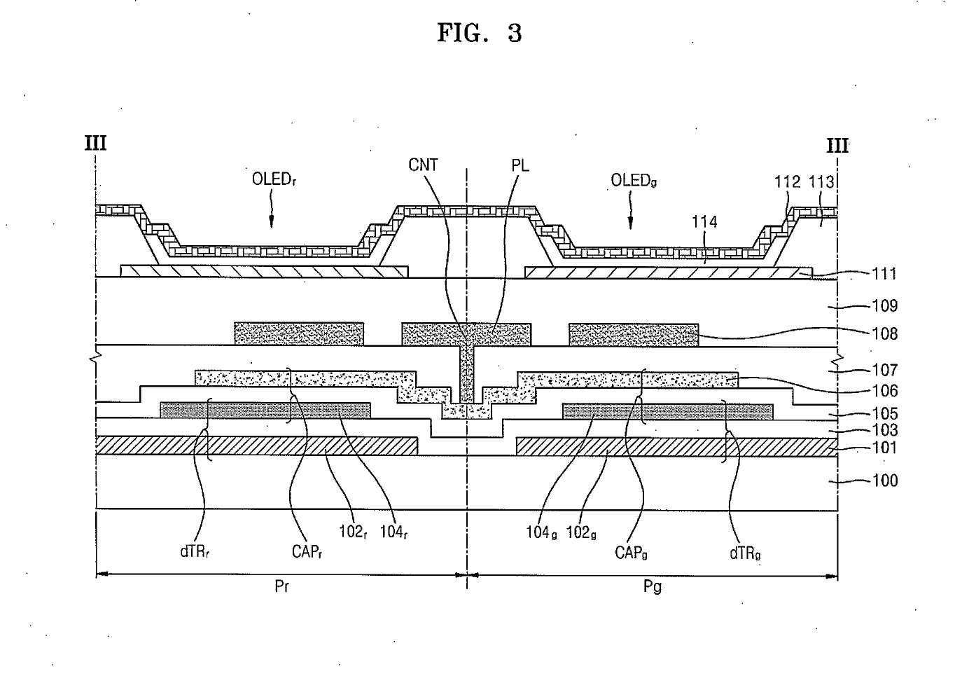

FIG. 2 is a detailed plan view of portion II of FIG. 1, illustrating two subpixels that are symmetric with respect to the first power line PL. FIG. 3 is a cross-sectional view taken along line III-III of FIG. 2.

In FIGS. 2 and 3, the red subpixel Pᵣ that is disposed on one side and the green subpixel P_{g} that is disposed on the other side of the first power line PL are representatively shown. Although subpixels that emit light of different colors include different types of organic light-emitting layers that are included in OLEDs, structures of the OLEDs or structures of pixel circuits that are connected to the OLEDs are the same. Accordingly, the red subpixel Pᵣ and the green subpixel P_{g} of FIGS. 2 and 3 will be representatively explained, and a repeated explanation about the other subpixels will not be given.

A subpixel includes an OLED that emits light and a pixel circuit unit that is electrically connected to the OLED and adjusts power on/off and a luminance of the OLED by using a driving current.

In FIGS. 2 and 3, the organic light-emitting display device 10 is structured such that a pixel circuit unit of a subpixel that is disposed on one side of the first power line PL and a pixel circuit unit of a subpixel that is disposed on other side of the first power line PL are symmetric with respect to the first power line PL, in order for the symmetric subpixels to commonly use the first power line PL. That is, since the subpixels are symmetric, the number of the first power lines PL may be reduced to n/2 when compared to a conventional case where the number of the first lines PL that are respectively provided in subpixels of a display area is n.

Referring to FIGS. 2 and 3, a buffer layer 101 is disposed on a substrate 100. The buffer layer 101 planarizes a top surface of the substrate 100 and prevents penetration of impurities thereinto. The buffer layer 101 may be a film formed of an inorganic material such as silicon oxide (SiOx) or silicon nitride (SiNx) to have a single-layer structure or a multi-layer structure. The buffer layer 101 may be formed by using any of various deposition methods. The buffer layer 101 may be omitted, if necessary.

A pixel circuit unit is disposed on the buffer layer 101. A subpixel includes the pixel circuit unit that includes at least two thin-film transistors (TFTs) and at least one capacitor. Although only a driving TFT and a capacitor are shown in FIG. 3, the present embodiment is not limited thereto, and the pixel circuit unit may include more TFTs and capacitors.

The driving TFT includes a semiconductor portion including a source region and a drain region, and a gate portion. Hereinafter, the driving TFT that is included in the red subpixel Pᵣ is referred to as a red driving TFT dTRᵣ, and the driving TFT that is included in the green subpixel P_{g} is referred to as a green driving TFT dTR_{g}. Elements included in each driving TFT are distinguished by using subscripts r indicating red and g indicating green.

The semiconductor portion is provided on the buffer layer 101. The semiconductor portion is formed by forming a semiconductor layer on the entire buffer layer 101 and performing a patterning process using a patterning mask. The semiconductor layer may include a semiconductor material, for example, amorphous silicon or polycrystalline silicon. However, the present embodiment is not limited thereto, and an active layer 102 may include an oxide semiconductor material such as G-I-Z-O [(In₂O₃)a(Ga₂O₃)b(ZnO)c] (a≧0, b≧0, and c>0).

The semiconductor portion may include a red semiconductor portion 102ᵣ and a green semiconductor portion 102_{g} which are connected to each other. Each of the red semiconductor portion 102ᵣ and the green semiconductor portion 102_{g} may include a source region (not shown) and a drain region (not shown). The source region and the drain region may be connected to another conductive layer through a contact hole, or may be connected to the semiconductor portion that is included in another TFT.

In FIGS. 2 and 3, each of the red semiconductor portion 102ᵣ and the green semiconductor portion 102_{g} has a curved shape with multiple turns. Accordingly, the semiconductor portion may have a maximum length even in a narrow area and a magnitude of a gate voltage of a driving TFT may be easily adjusted, thereby making it possible for each subpixel to provide a high grayscale display.

A first gate insulating film 103 is disposed on the semiconductor portion. The first gate insulating film 103 may be a film formed of an inorganic material such as silicon oxide and/or silicon nitride to have a multi-layer structure or a single-layer structure. The first gate insulating film 103 insulates the semiconductor film from a first gate portion.

The first gate portion is provided on the first gate insulating film 103. The first gate portion is formed by forming a first gate layer on the entire first gate insulating film 103, and then performing a patterning process using an appropriate patterning mask. The first gate layer may be a film formed of a conductive material including, for example, molybdenium (Mo), aluminum (Al), copper (Cu), or titanium (Ti), to have a multi-layer structure or a single-layer structure.

The first gate portion includes a red first gate portion 104ᵣ and a green first gate portion 104_{g}. Each of the red first gate portion 104ᵣ and the green first gate portion 104_{g} may be patterned as a floating electrode. However, each of the red first gate portion 104ᵣ and the green first gate portion 104_{g} may be connected to another layer through a contact structure and may receive a gate signal. The red first gate portion 104ᵣ functions as a gate electrode in the red driving TFT dTRᵣ, and to this end, is widely provided to cover the red semiconductor portion 102ᵣ. The red first gate portion 104_{g} functions as a gate electrode in the green driving TFT dTR_{g}, and to this end, is widely provided to cover the green semiconductor portion 102_{g}.

A second gate insulating film 105 is disposed on the first gate portion. The second gate insulating film 105 may be a film formed of an inorganic material such as silicon oxide and/or silicon nitride to have a multi-layer structure or a single-layer structure, like the first gate insulating film 103. The second gate insulating film 105 insulates the first gate portion from a second gate portion 106.

The second gate portion 106 is provided on the second gate insulating film 105. The second gate portion 106 is formed by forming a second gate layer on the entire second gate insulating film 105 and then performing a patterning process using an appropriate patterning mask. The second gate layer may be formed of a metal material having a low resistance, and may be a film formed of a conductive material including, for example, Mo, Al, Cu, or Ti, to have a multi-layer structure or a single-layer structure, like the first gate layer.

The second gate portion 106 is patterned as one floating electrode. The second gate portion 106 is commonly provided in the red subpixel Pᵣ and the green subpixel P_{g}. In detail, the second gate portion 106 overlaps with the red first gate portion 104ᵣ and the green first gate portion 104_{g}.

In FIGS. 2 and 3, the red first gate portion 104ᵣ and the second gate portion 106 overlap with each other to form a red capacitor CAPᵣ. Likewise, the green first gate portion 104_{g} and the second gate portion 106 overlap with each other to form a green capacitor CAP_{g}. That is, a capacitor that is included in the red subpixel Pᵣ and a capacitor that is included in the green subpixel P_{g} commonly use an upper electrode.

In FIGS. 2 and 3, a gate electrode of a driving TFT and a lower electrode included in a capacitor in a subpixel use the same member, and thus the driving TFT and the capacitor inevitably overlap each other. In this case, since a smaller space may be used and more subpixels may be formed in a given display area when compared to a general case where a driving TFT and a capacitor are arranged in parallel on one plane, the organic light-emitting display device 10 may have a high resolution.

An interlayer insulating film 107 is disposed on the second gate portion 106. The interlayer insulating film 107 may be a film formed of an inorganic material to have a multi-layer structure or a single-layer structure. For example, the inorganic material may be a metal oxide or a metal nitride, and in detail, examples of the inorganic material may include silicon oxide (SiO₂), silicon nitride (SiNx), silicon oxynitride (SiON), aluminum oxide (Al₂O₃), titanium oxide (TiO₂), tantalum oxide (Ta₂O₅), hafnium oxide (HfO₂), and zinc oxide (ZrO₂). The interlayer insulating film 107 insulates the second gate portion 106 from a source drain portion 108.

The source drain portion 108 is provided on the interlayer insulating film 107. The source drain portion 108 is formed by forming a source drain layer on the entire interlayer insulating film 107 and then performing a patterning process using an appropriate patterning mask. The source drain layer may be formed of a metal material having a low resistance, and may be a film formed of a conductive material including, for example, Mo, Al, Cu, or Ti, to have a multi-layer structure or a single-layer structure.

The source drain portion 108 includes various lines or connection units having contact structures. In particular, in FIGS. 2 and 3, the source drain portion 108 includes the first power line PL. The first power line PL is directly connected to the second gate portion 106 through a contact hole CNT of the interlayer insulating film 107. In detail, the contact hole CNT is formed to expose a central portion of the second gate portion 106, and the first power line PL directly contacts the central portion of the second gate portion 106.

In FIGS. 2 and 3, the first power line PL is not provided in each of the red subpixel Pᵣ and the green subpixel P_{g}. That is, one first power line PL is commonly provided in the red subpixel Pᵣ and the green subpixel P_{g}. This is possible because the red subpixel Pᵣ and the green subpixel P_{g} commonly use the second gate portion 106 and the first power line PL is connected to the second gate portion 106. Accordingly, the organic light-emitting display device 10 may form an image having a high resolution by reducing the number of the first power lines PL and forming more subpixels in a given display area.

A planarization film 109 is formed to cover the source drain portion 108. The planarization film 109 may be a film formed of an inorganic material and/or an organic material to have a single-layer structure or a multi-layer structure. For example, the inorganic material may be a metal oxide or a metal nitride. In detail, examples of the inorganic material may include SiO₂, SiNx, SiON, Al₂O₃, TiO₂, Ta₂O₅, HfO₂, and ZrO₂. Examples of the organic material may include a general-purpose polymer such as polymethylmethacrylate (PMMA) or polystyrene (PS), a polymer derivative having a phenol-based group, an acryl-based polymer, an imide-based polymer, an aryl ether-based polymer, an amide-based polymer, a fluorine-based polymer, a p-xylene-based polymer, a vinyl alcohol-based polymer, and a blend thereof. Also, the planarization film 109 may be formed as a stack of an inorganic insulating film and an organic insulating film. The planarization film 109 prevents a problem from being caused in the OLED due to a lower uneven portion by removing a stepped portion that is formed due to the TFT array and planarizing a top surface.

The OLED is formed on the planarization film 109. The OLED is provided to overlap the pixel circuit unit and cover at least a part of the pixel circuit unit. This is because, in this case, more subpixels may be formed in the given display area DA when compared to a case where the pixel circuit unit and the OLED are provided not to overlap with each other.

The OLED includes a pixel electrode 111 that is formed on the planarization film 109, a counter electrode 112 that faces the pixel electrode 111, and an intermediate layer 114 that is disposed between the pixel electrode 111 and the counter electrode 112. Display devices are classified into bottom emission display devices, top emission display devices, and dual emission display devices according to an emission direction in which an OLED emits light. In FIGS. 2 and 3, since the pixel circuit unit and the OLED overlap with each other, the organic light-emitting display device 10 is determined to be of a top emission display device. In embodiments, the pixel electrode 111 may be reflective, and the counter electrode 112 may be substantially transparent, semi-transparent or semi-transmissive.

The pixel electrode 111 may function as an anode by including at least one selected from the group consisting of indium tin oxide (ITO), indium zinc oxide (IZO), zinc oxide (ZnO), indium oxide (In₂O₃), indium gallium oxide (IGO), and aluminum zinc oxide (AZO) having a high work function. In order to emit light away from the substrate 100, the pixel electrode 111 includes a reflective layer formed of silver (Ag). The pixel electrode 111 may be patterned into an island shape corresponding to each pixel. Also, the pixel electrode 111 may be electrically connected to the driving TFT and may receive driving current. When the pixel electrode 111 is “electrically connected” to the driving TFT, it may mean that the driving TFT and the pixel electrode 111 may be directly connected to each other or the driving TFT and the pixel electrode 111 may be indirectly connected via another TFT. In FIGS. 2 and 3, the driving TFT may be directly connected to the pixel electrode 111, or may be indirectly connected to the pixel electrode 111 via another TFT.

A pixel-defining layer (PDL) that is formed of an insulating material is formed on the pixel electrode 111 to cover the pixel electrode 111. The PDL 113 may be formed of at least one organic insulating material selected from the group consisting of polyimide, polyamide, acrylic resin, benzocyclobutene, and phenolic resin, and may be formed by using spin coating or the like. A predetermined opening that defines a light-emitting area in each pixel is formed in the PDL 113. The intermediate layer 114 is formed in an area defined by at least the opening.

The intermediate layer 114 may include an organic light-emitting layer that emits red, green, or blue light according to each subpixel, and the organic light-emitting layer may be formed of a low molecular weight organic material or a high molecular weight organic material. In FIG. 3, the red subpixel Pᵣ includes an organic light-emitting layer that emits red light, and the green subpixel P_{g} includes a subpixel that emits green light.

When the organic light-emitting layer is formed of a low molecular weight organic material, a hole transport layer (HTL) and a hole injection layer (HIL) are disposed close to the pixel electrode 111, and an electron transport layer (ETL) and an electron injection layer (EIL) are stacked close to the counter electrode 112. The organic light-emitting layer may be formed by stacking various layers other than the HIL, the HTL, the ETL, and the HIL, if necessary.

In FIGS. 2 and 3, an organic light-emitting layer is formed in each pixel. In this case, red, green, and blue light may be respectively emitted from pixels, and a group of pixels that emit red, green, and blue light may form one unit pixel. However, the present embodiment is not limited thereto, and an organic light-emitting layer may be commonly formed over an entire pixel. For example, a plurality of organic light-emitting layers that emit red, green, and blue light may be vertically stacked or combined to emit white light. However, a combination of colors for emitting white light is not limited thereto. In this case, a color shift layer or a color filter for converting emitted white light into light of a predetermined color may be separately provided.

The counter electrode 112 may be formed of a conductive inorganic material. The counter electrode 112 may be formed of lithium (Li), calcium (Ca), LiF/Ca, LiF/Al, Al, magnesium (Mg), or Ag having a low work function, and may function as a cathode. Since light has to be emitted away from the substrate 100, the counter electrode 112 has to be an electrode that is a film formed of any of the above materials and allows light to transmit therethrough. The counter electrode 112 may be formed as a common electrode over the entire display area DA on which an image is formed, and a second power voltage is applied to the counter electrode 112. The second power voltage may be a low potential voltage that is used to determine driving current of the OLED. In this case, the counter electrode 112 may be formed by performing evaporation that does not damage the intermediate layer 114.

Polarities of the pixel electrode 111 and the counter electrode 112 may be opposite to each other.

An effect of the one or more embodiments of the present invention will be explained through comparison with a comparative example.

FIG. 4 is a plan view illustrating an organic light-emitting display device 10a according to a comparative example. FIG. 5 is a detailed plan view illustrating portion V of FIG. 4.

In the organic light emitting display device 10a, in combination of the first unit pixel UP1 and the second unit pixel UP2, the number the red subpixels Pᵣ, the blue subpixels P_{b}, or the green subpixel P_{g} that are disposed on one side (for example, a left side) of the first power line PL and the number of the red subpixels Pᵣ, the blue subpixels P_{b}, or the green subpixels P_{g} that are disposed on the other side (for example, a right side) of the first power line PL are different from each other.

In detail, referring to FIG. 4, the red subpixel Pᵣ and the blue subpixel P_{b} are alternately provided on one side, and only the green subpixels P_{g} are provided on other side of the first power line PL. In embodiments, the organic light-emitting display device 10a may have a general PenTile matrix color pixel arrangement. When subpixels are arranged as shown in FIG. 4, the following problems are caused.

FIG. 5 is a detailed plan view illustrating the portion V of the organic light-emitting display device 10a of FIG. 4. In FIG. 5, the second gate portion 106 of FIG. 2 is misaligned by being slightly shifted in a +X axis. The misalignment may occur when a predetermined patterning mask is misaligned in a process of forming the second gate layer 106 and then patterning the second gate layer 106 by using the predetermined patterning mask.

If the second gate portion 106 is misaligned as shown in FIG. 5, capacitances of red and blue capacitors that are included in the red and blue subpixels Pᵣ and P_{b} are reduced, and a capacitance of a green capacitor that is included in the green subpixel P_{g} is increased. Accordingly, luminance of the red and blue subpixels Pᵣ and P_{b} are reduced, and a luminance of the green subpixel P_{g} is increased. Since only the luminance of green light is increased in the entire display area DA, a color abnormality occurs.

Also, if the second gate portion 106 is misaligned as shown in FIG. 5, the second gate portion 106 and other layer (for example, the semiconductor portion or the first gate portion) overlap each other, thereby leading to a undesired parasitic capacitance.

Although the second gate portion 106 is misaligned only in the X direction in FIG. 5, if the second gate portion 106 is misaligned by being rotated, the color abnormality occurs in more various ways and various parasitic capacitances may be formed.

Although only the second gate portion 106 is misaligned in FIG. 5, such misalignment may occur in any layer that undergoes patterning by using a patterning mask, for example, the semiconductor portion, the first gate portion, or the source drain portion.

As a result, with regard to the subpixels that are included in at least two unit pixels that are adjacent to each other in an extension direction in which the first power line PL extends and are electrically connected to the first power line PL as shown in FIG. 4, if the number of subpixels of a specific color that are disposed on one side of the first power line PL and the number of subpixels of the specific color that are disposed on other side are not the same, the organic light-emitting display device 10a may be affected by a problem that is inevitably caused during a manufacturing process.

However, according to the embodiment of FIG. 1, even when a problem such as misalignment of a patterning mask occurs during a manufacturing process, color abnormality may be reduced to some extent by improving an arrangement of the subpixels. Thus, the organic light-emitting display device 10 having reduced color shift and color abnormality may be manufactured.

Referring back to FIG. 1, in embodiments, the unit pixels UP1 and the unit pixels UP2 may be alternately arranged along a power line PL. As the result, the organic light-emitting display device 10 illustrated in FIG. 1 may include a large number of red, blue and green color pixels Pr, Pb and Pg formed over the substrate. In the embodiments, the number of the red color pixels disposed on the right side of the power line PL may be substantially the same as that of the red color pixels disposed on the left side of the power line PL. Similarly, the number of the blue color pixels disposed on the right side of the power line PL may be substantially the same as that of the blue color pixels disposed on the left side of the power line PL. Also, the number of the green color pixels disposed on the right side of the power line PL may be substantially the same as that of the green color pixels disposed on the left side of the power line PL.

In alternative embodiments, each of the unit pixels UP1 and UP2 may include red color pixels more than one, blue color pixels more than one, and green pixels more than one, and the unit pixels UP1 and the unit pixels UP2 can be alternately arranged along a power line PL. In those alternative embodiments, all the red, blue and green color pixels connected to one power line PL may be arranged such that the number of the red color pixels disposed on the right side of the power line PL is substantially the same as that of the red color pixels disposed on the left side of the power line PL, that the number of the blue color pixels disposed on the right side of the power line PL is substantially the same as that of the blue color pixels disposed on the left side of the power line PL, and that the number of the green color pixels disposed on the right side of the power line PL is substantially the same as that of the green color pixels disposed on the left side of the power line PL so as to reduce or minimize risks or possibility of color abnormality caused by misalignment of a patterning mask during a manufacturing process.

As described above, even when a patterning mask is misaligned during a manufacturing process, an organic light-emitting display device according to the one or more of the above embodiments of the present invention may prevent color shift due to an improved pixel arrangement.

While one or more embodiments of the present invention have been described with reference to the attached figures, it will be understood by those of ordinary skill in the art that various changes in form and details may be made therein without departing from the spirit and scope of the present invention as defined by the following claims. Accordingly, the true technical scope of the inventive concept is defined by the technical spirit of the appended claims.

What is claimed is:

1. An organic light-emitting display device comprising:
a substrate;
two unit pixels disposed over the substrate, immediately neighboring each other, and each comprising a plurality of subpixels, each of which is configured to emit light having one of red, blue, and green colors; and
a power line formed over the substrate, line extending in a direction to apply a voltage to each of the plurality of subpixels in order for the plurality of subpixels to emit light,
wherein the subpixels included in the two unit pixels are arranged such that the number of the subpixels that are configured to emit light having a first color or a second color among the red, blue, and green colors and are disposed on one side of the power line is the same as that of the subpixels that are configured to emit light having the first color or the second color and are disposed on the other side of the power line.

2. The organic light-emitting display device of claim 1, wherein each unit pixel comprises, one red subpixel configured to emit light having the red color, one blue subpixel configured to emit light having the blue color, and two green subpixels configured to emit light having the green color.

3. The organic light-emitting display device of claim 2, wherein the red subpixel and one of the green subpixels immediately neighbor each other and are disposed on one side and the other side of the power line, respectively, and wherein the blue subpixel and the remaining green subpixel immediately neighbor each other and are disposed on one side and the other side of the power line, respectively.

4. The organic light-emitting display device of claim 1, wherein each of the plurality of subpixels comprises an organic light-emitting device (OLED), a driving thin-film transistor (TFT) connected to the OLED to supply driving current to the OLED and comprising a semiconductor and a gate electrode, and a capacitor connected to the driving TFT and comprising a lower electrode and an upper electrode,
wherein the driving TFT and the capacitor overlap each other when viewed in a viewing direction perpendicular to a major surface of the substrate, wherein the gate electrode of the driving TFT and the lower electrode of the capacitor are integrated as a single piece.

5. The organic light-emitting display device of claim 4, wherein the plurality of subpixels comprises two subpixels that immediately neighbor each other and are disposed on one side and the other side of the power line, respectively, wherein the upper electrodes of the capacitors of the two subpixels are integrated as a single piece.

6. The organic light-emitting display device of claim 5, wherein the power line contacts a central portion of the single piece of the upper electrodes to apply the voltage to the two subpixels.

7. The organic light-emitting display device of claim 5, wherein the driving TFTs included in the two subpixels are symmetric with respect to the power line.

8. The organic light-emitting display device of claim 6, wherein the semiconductor in the driving TFT has a curved shape with multiple turns.

9. The organic light-emitting display device of claim 6, wherein the OLED comprises a pixel electrode, a counter electrode opposing the pixel electrode, and an organic light-emitting layer that is disposed between the pixel electrode and the counter electrode and is configured to emit light,
wherein the pixel electrode is configured to reflect the light to the counter electrode.

10. The organic light-emitting display device of claim 9, wherein the OLED overlaps and covers the driving TFT and the capacitor when viewed in the viewing direction.

11. An organic light-emitting display device comprising:
a substrate;
a plurality of color pixels formed over the substrate, and comprising first color pixels each configured to emit light having a first color, second color pixels each configured to emit light having a second color, and third color pixels each configured to emit light having a third color; and
a power line formed over the substrate and extending in an extending direction to apply a voltage to each of the plurality of color pixels in order for the plurality of color pixels to emit light, wherein each of a plurality of color pixels are disposed on a first side of the power line or a second side of the power line opposite the first side,
wherein the number of the first color pixels disposed on the first side is substantially the same as that of the first color pixels disposed on the second side.

12. The device of claim 11, wherein the number of the second color pixels disposed on the first side is substantially the same as that of the second color pixels disposed on the second side.

13. The device of claim 11, wherein the number of the second color pixels disposed on the first side is substantially the same as that of the second color pixels disposed on the second side, wherein the number of the third color pixels disposed on the first side is substantially the same as that of the third color pixels disposed on the second side.

14. The device of claim 11, wherein the first color pixels are arranged such that each of the first color pixels disposed on the first side is disposed side by side with one of the third color pixels disposed on the second side.

15. The device of claim 11, wherein each of the first color pixels disposed on the first side are paired with one of the third color pixels disposed on the second side such that the paired first and third color pixels are disposed side by side with each other, wherein each of the paired first and third color pixels comprises a capacitor, wherein the capacitors of the paired first and third color pixels comprise a single common electrode.

16. The device of claim 11, wherein the first color pixels are arranged such that each of the first color pixels disposed on the first side is disposed side by side with one of the third color pixels disposed on the second side, wherein the second color pixels are arranged such that each of the second color pixels disposed on the first side is disposed side by side with one of the third color pixels disposed on the second side.

17. The device of claim 11, wherein the plurality of color pixels are arranged on the first side or the second side such that each of the first color pixels disposed on the first side is not disposed side by side with one of the first color pixels disposed on the second side.

18. The device of claim 11, wherein the plurality of color pixels are arranged on the first side or the second side such that each of the first color pixels disposed is not disposed side by side with another first color pixel.

19. The device of claim 11, wherein the first color is red, the second color is blue and the third color is green.

20. The device of claim 11, wherein the plurality of color pixels have substantially the same size when viewed in a viewing direction perpendicular to a major surface of the substrate.
